(19) United States
(12) Patent Application Publication
(10) Pub. No.: US 2021/0056418 A1
(43) Pub. Date: Feb. 25, 2021

(54) LEARNING DEVICE, LEARNING METHOD, AND LEARNING PROGRAM

(71) Applicant: NIPPON TELEGRAPH AND TELEPHONE CORPORATION, Tokyo (JP)

(72) Inventors: Sekitoshi KANAI, Musashino-shi (JP); Yasuhiro FUJIWARA, Musashino-shi (JP); Yuki YAMANAKA, Musashino-shi (JP)

(73) Assignee: NIPPON TELEGRAPH AND TELEPHONE CORPORATION, Tokyo (JP)

(21) Appl. No.: 17/045,765

(22) PCT Filed: Apr. 22, 2019
(86) PCT No.: PCT/JP2019/017094

§ 371 Date: Oct. 7, 2020

(30) Foreign Application Priority Data
Apr. 24, 2018 (JP) 2018-083122

(51) Int. Cl. G06N 3/08; G06N 3/04; G06F 7/556

(52) U.S. Cl. CPC G06N 3/08; G06F 7/556; G06N 3/04

(57) ABSTRACT

A calculation unit (121) calculates, for an output signal of an output layer in a neural network, an output function obtained by replacing an exponential function included in softmax with a product of the exponential function and a predetermined function having no parameter, the output function having a non-linear log likelihood function. An update unit (122) updates a parameter of the neural network on the basis of the output signal such that the log likelihood function of the output function is optimized.

### TECHNICAL FIELD

The present invention relates to a learning device, a learning method, and a learning program.

### BACKGROUND ART

For example, a method in which deep learning using multilayers of a neural network is used to output the probability of classes of objects (such as car and dog) appearing in images is known. In such a method of deep learning, an output function for outputting a vector such that the sum of all elements is 1 and each value is in [0;1] is used to express the probability of each class. In particular, softmax is sometimes used as the output function due to compatibility with the cross entropy used for learning (see, for example, NPL 1). To improve the expression ability of deep learning, a method called “mixture of softmax (Mos)” in which a plurality of softmax outputs are mixed is known (see, for example, NPL 2).

### CITATION LIST

### Non Patent Literature

[NPL 1] Ian Goodfellow, Yoshua Bengio, and Aaron Courville. Deep learning. MIT press, 2016.
[NPL 2] Zhilin Yang et al. Breaking the softmax bottleneck: a high-rank RNN language model. In: arXivpreprint arXiv:1711.03953 (2017).

### SUMMARY OF THE INVENTION

### Technical Problem

The conventional method, however, has a problem in that it may be difficult to efficiently perform deep learning with improved expression ability. For example, when learning is performed by using the method disclosed in NPL 2, as compared with the case where softmax is used, it is necessary to additionally set parameters to be learned and parameters to be adjusted, which may decrease the efficiency.

### Means for Solving the Problem

In order to solve the above-mentioned problems and achieve the object, a learning device in the present invention includes: a calculation unit for calculating an output function whose variable is an output signal of an output layer in a neural network, the output function having a non-linear log likelihood function; and an update unit for updating a parameter of the neural network on the basis of the output signal such that the log likelihood function of the output function is optimized.

### Effects of the Invention

According to the present invention, deep learning with improved expression ability can be efficiently performed.

### BRIEF DESCRIPTION OF DRAWINGS

FIG. 1 is a block diagram illustrating a configuration example of a learning device according to a first embodiment.

FIG. 2 is a diagram for describing the outline of processing by the learning device according to the first embodiment.

FIG. 3 is a diagram illustrating an example of pseudocode of the processing by the learning device according to the first embodiment.

FIG. 4 is a flowchart for describing the processing by the learning device according to the first embodiment.

FIG. 5 is a diagram illustrating a computer for executing a learning program.

### DESCRIPTION OF EMBODIMENTS

A learning device, a learning method, and a learning program according to an embodiment of the present application are described in detail below with reference to the drawings. Note that the present invention is not limited by the embodiment described below.

[Output of Conventional Deep Learning]

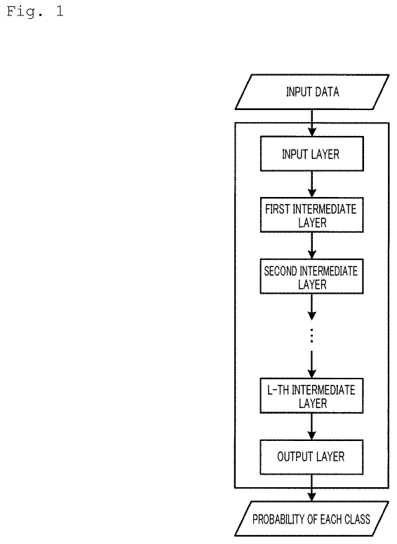

First, deep learning is described with reference to FIG. 1. FIG. 1 is a diagram for describing a model of deep learning. In particular, a model for performing classification is described. As illustrated in FIG. 1, a model of deep learning has an input layer, one or more intermediate layers, and an output layer.

Input data is input to the input layer. The probability of each class is output from the output layer. For example, the input data is image data represented in a predetermined format. Also for example, when classes are set for cars, ships, dogs, and cats, the probability of the image being one of a car, the probability of the image being one of a ship, the probability of the image being one of a dog, and the probability of the image being one of a cat that are the base of the input data are output from the output layer.

Conventionally, softmax is used in order to output the probability from the output layer. When an output signal of the L-th intermediate layer, which is the last intermediate layer, is u∈R′, y∈R^{K} in Formula (1) using softmax is output from the output layer.

$$\begin{matrix}[ Formula 1 ] & \\ {[ y ]}_{i} = \frac{exp ( {[ Wu ]}_{i} )}{{\sum }_{j = 1}^{K} exp ( {[ Wu ]}_{j} )} & ( 1 )\end{matrix}$$

The matrix W in Formula (1) is a parameter called “weighting” learned in deep learning.

[y]ᵢ is the i-th element of a vector y. In Formula (1), softmax performs non-linear transformation using an exponential function for the vector Wu after the weight calculation. The i-th element [y]ᵢ of the output vector y indicates, for example, the probability when the input is a class i.

The denominator of the right-hand side of Formula (1) is the sum of exponential functions of the elements, and hence each element [y]ᵢ is 1 or less. The exponential function takes a value of 0 or greater, and hence each output element [y]ᵢ is in the range of [0,1]. Thus, Formula (1) can express the probability.

However, softmax has a limit of the expression ability. First, log softmax taking the log of softmax will be considered. The log softmax is included in a log likelihood function of softmax. log softmax:f is a vector-valued function of R^{X}→R^{X}. The i-th element of f(x) is indicated as Formula (2).

$$\begin{matrix}[ Formula 2 ] & \\ {[ f ( x ) ]}_{i} = \frac{exp ( {[ x ]}_{i} )}{{\sum }_{j = 1}^{K} exp ( {[ x ]}_{j} )} & ( 2 )\end{matrix}$$

It is assumed that there are N samples of the vector u input to the model, and the i-th input is u⁽ⁱ⁾. In this case, the dimension of a space formed by all inputs u⁽¹⁾, . . . , u^{(N)}, U=span (u⁽¹⁾, . . . , u^{(N)}, is r. In other words, r linearly independent inputs are present in the input to the model. Then, Formula (3) is established for the space formed by the vector Wu⁽ⁱ⁾ (i=1, . . . , N).

[Formula 3]

dim(span(Wu⁽¹⁾, . . . ,Wu^{(N)}))−min(rank(W),r) (3)

Now, an output space Y of log softmax will be considered. From the relation of the log and the division, Formula (2) is modified to Formula (4).

$$\begin{matrix}[ Formula 4 ] & \\ {[ f ( x ) ]}_{i} = {x}_{i} - log {\sum }_{j = 1}^{K} exp ( {[ x ]}_{j} ) & ( 4 )\end{matrix}$$

f(x) is as expressed by Formula (5).

$$\begin{matrix}[ Formula 5 ] & \\ f ( x ) = x - c 1 , c = log {\sum }_{j = 1}^{m} exp ( {[ x ]}_{j} ) & ( 5 )\end{matrix}$$

Thus, y⁽ⁱ⁾ is as expressed by Formula (6).

[Formula 6]

y⁽ⁱ⁾=f(Wu⁽ⁱ⁾)=Wu⁽ⁱ⁾−c⁽ⁱ⁾1 (6)

A space Y formed by output with respect to the L linearly independent inputs Wu⁽ⁱ⁾, Y=span(y⁽¹⁾, . . . , y^{(N)}), is as indicated by Formula (7).

$$\begin{matrix} [ Formula 7 ] & \\ span ( {y}^{( 1 )} , … , {y}^{( N )} ) = \{ {k}_{1} ( {Wu}^{( 1 )} + … + {k}_{L} {Wu}^{( L )} + {\sum }_{l = 1}^{L} ( - {k}_{l} {c}^{( l )} ) 1 \vert {k}_{1} , … , {k}_{L} ∈ R \} & ( 7 )\end{matrix}$$

Thus, the dimension of Y is as indicated by Formula (8).

$$\begin{matrix} [ Formula 8 ] & \\ dim ( Y ) = \{ \begin{matrix}L + 1 & if 1 ∉ \{ {c}_{1} Wu ( 1 ) + … + {c}_{L} {Wu}^{( L )} \vert {c}_{1} , … , {c}_{L} ∈ R \} \\ L & 1 ∈ \{ {c}_{1} Wu ( 1 ) + … + {c}_{L} {Wu}^{( L )} \vert {c}_{1} , … , {c}_{L} ∈ R \}\end{matrix} & ( 8 )\end{matrix}$$

From the above, the space formed by the output y is as indicated by Formula (9).

$$\begin{matrix} [ Formula 9 ] & \\ dim ( Y ) = \{ \begin{matrix}min ( rank ( W ) , r ) + 1 & if 1 ∉ \{ \begin{matrix}{c}_{1} Wu ( 1 ) + … + \\ {c}_{L} {Wu}^{( L )} \vert {c}_{1} , … , {c}_{L} ∈ R\end{matrix} \} \\ min ( rank ( W ) , r ) & 1 ∈ \{ \begin{matrix}{c}_{1} Wu ( 1 ) + … + \\ {c}_{L} {Wu}^{( L )} \vert {c}_{1} , … , {c}_{L} ∈ R\end{matrix} \}\end{matrix} & ( 9 )\end{matrix}$$

Itis understood that from Formula (9), if a space formed by true output vectors is m>min (rank(W), r)+1, the space cannot be expressed by log softmax. As described above, in the conventional deep learning using softmax, the expression ability is limited due to the linear log likelihood function of the output function.

In view of the above, in the embodiment, an output function having a non-linear log likelihood function is used to improve the expression ability of deep learning. Further, the same parameter as in the conventional softmax can be used as a parameter of the output function used in the embodiment, and hence the setting of a new learning parameter is unnecessary.

### Configuration in First Embodiment

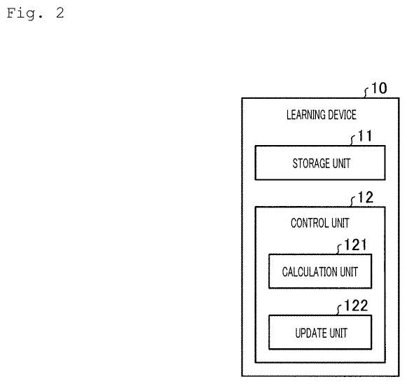

First, a configuration of a learning device according to a first embodiment is described with reference to FIG. 2. FIG. 2 is a diagram illustrating an example of the configuration of the learning device according to the first embodiment. As illustrated in FIG. 2, a learning device 10 includes a storage unit 11 and a control unit 12.

The storage unit 11 is a storage device such as a hard disk drive (HDD), a solid state drive (SSD), and an optical disc. Note that the storage unit 11 may be a data rewritable semiconductor memory such as a random access memory (RAM), a flash memory, and a non-volatile static random access memory (NVSRAM). The storage unit 11 stores therein an operating system (OS) and various kinds of programs executed by the learning device 10. The storage unit 11 stores therein various kinds of information used to execute the programs. The storage unit 11 stores therein parameters of a model of deep learning.

The control unit 12 controls the entire learning device 10. For example, the control unit 12 is an electronic circuit such as a central processing unit (CPU) and a microprocessing unit (MPU), or an integrated circuit such as an application specific integrated circuit (ASIC) and a field programmable gate array (FPGA). The control unit 12 has an internal memory for storing therein programs defining various kinds of processing procedures and control data, and executes the processing by using the internal memory. The control unit 12 functions as various kinds of processing units when various kinds of programs operate. For example, the control unit 12 includes a calculation unit 121 and an update unit 122.

The calculation unit 121 calculates an output function whose variable is an output signal of an output layer in a neural network, the output function having a non-linear log likelihood function. For example, the calculation unit 121 calculates, for the output signal of the output layer in the neural network, an output function obtained by replacing an exponential function included in softmax with the product of the exponential function and a predetermined function having no parameter, the output function having a non-linear log likelihood function. Here, the calculation unit 121 calculates an output function obtained by replacing an exponential function included in softmax with the product of the exponential function and a sigmoid function.

As described above, in the conventional deep learning using softmax, Formula (5) taking the log of an output function does not have a non-linear element, and calculates the sum of the input vector Wu and 1 vector multiplied by a scalar. Thus, the expression ability is limited.

In view of the above, the learning device 10 in the embodiment uses, as the output function, a function obtained by replacing an exponential function included in softmax with the product of the exponential function and a sigmoid function. The output function in the embodiment is g(x) in Formula (10). The sigmoid function is σ([x]) in Formula (10).

$$\begin{matrix}[ Formula 10 ] & \\ {[ g ( x ) ]}_{i} = \frac{exp ( {[ x ]}_{i} ) σ ( {[ x ]}_{i} )}{{\sum }_{j}^{K} exp ( {[ x ]}_{j} ) σ ( {[ x ]}_{j} )} \\ σ ( [ x ] ) = \frac{1}{1 + exp ( - {[ x ]}_{i} )} & ( 10 )\end{matrix}$$

In this manner, in the output layer, the calculation unit 121 calculates an output function whose variable is only an output signal. Thus, in this embodiment, a learning parameter for the output function is unnecessary, and the calculation unit 121 calculates an output function having no parameter, whose variable is only an output signal of the output layer in the neural network.

As indicated by Formula (11), the log of the output function g(x) has a non-linear element −log(1+exp(x)). −log(1+exp(x)) is a vector-valued function for non-linear transformation.

$$\begin{matrix}[ Formula 11 ] & \\ log ( g ( x ) ) = 2 x - log ( 1 + exp ( x ) ) + c 1 \\ c = {\sum }_{j}^{K} exp ( {[ x ]}_{j} ) σ ( [ {x}_{j} ] ) & ( 11 )\end{matrix}$$

In this manner, in the model of deep learning in the embodiment, the log likelihood function of the output function is non-linear, and hence the space of output is not limited by the dimension of input, and the expression ability is not limited. Formula (10) is formed by using only the same parameter as in Formula (2) of the conventional softmax.

The update unit 122 updates the parameter of the neural network on the basis of the output signal such that the log likelihood function of the output function is optimized. For example, the update unit 122 updates the matrix W having the parameter stored in the storage unit 11.

The case where the calculation unit 121 calculates an output function obtained by replacing an exponential function included in softmax with the product of the exponential function and a sigmoid function has been described above. On the other hand, the output function is not limited to the one described above, and may be a function having a non-linear log and obtained by replacing an exponential function of softmax with another function. For example, the calculation unit 121 can use a function obtained by replacing an exponential function of softmax with a sigmoid function as indicated by Formula (12) as the output function.

$$\begin{matrix}[ Formula 12 ] & \\ {[ g ( x ) ]}_{i} = \frac{σ ( {[ x ]}_{i} )}{{\sum }_{j}^{K} σ ( {[ x ]}_{j} )} & ( 12 )\end{matrix}$$

The calculation unit 121 can calculate a function obtained by replacing an exponential function of softmax with softplus as the output function as indicated by Formula (13). In other words, the calculation unit 121 can calculate an output function obtained by replacing an exponential function included in softmax with any one of the product of the exponential function and a sigmoid function, a sigmoid function, and softplus.

$$\begin{matrix}[ Formula 13 ] & \\ {[ g ( x ) ]}_{i} = \frac{log ( 1 + exp ( {[ x ]}_{i} ) )}{{\sum }_{j}^{K} log ( 1 + exp ( {[ x ]}_{j} ) )} & ( 13 )\end{matrix}$$

### Processing in First Embodiment

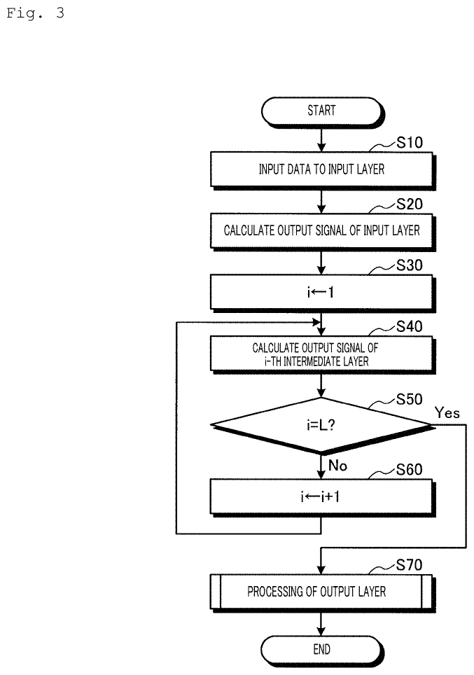

Referring to FIG. 3, the flow of processing in the learning device 10 will be described. FIG. 3 is a flowchart illustrating the flow of learning processing according to the first embodiment. As illustrated in FIG. 3, first, the learning device 10 accepts input of input data to the input layer (Step S10).

Next, the learning device 10 calculates an output signal of the input layer (Step S20). Then, the learning device 10 sets i to 1 (Step S30), and calculates an output signal of the i-th layer (Step S40) until i=L is established (No at Step S50) while increasing i one by one (Step S60). In other words, the learning device 10 calculates output signals of intermediate layers from the first layer to the L-th layer, and obtains an output signal of the L-th layer. Then, the learning device 10 performs processing on the output layer (Step S70).

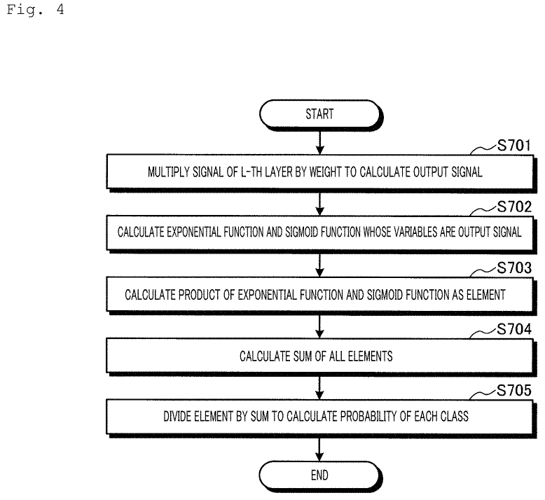

Referring to FIG. 4, the processing of the output layer by the learning device 10 will be described. As illustrated in FIG. 4, the learning device 10 first multiplies an output signal of the L-th layer, which is the last intermediate layer, by a weight to calculate an output signal of the output layer (Step S701). For example, when the output signal of the L-th intermediate layer is represented by a vector u and the weight is represented by a matrix W, the learning device 10 calculates Wu.

Next, the learning device 10 calculates an exponential function and a sigmoid function whose variables are the output signal (Step S702). For example, when the output signal is a vector x, the learning device 10 calculates an exponential function exp([x]ᵢ) and a sigmoid function σ([x]ᵢ) for the i-th element of the vector x. Note that σ( ) is as expressed by Formula (10).

Then, the learning device 10 calculates the product of the exponential function and the sigmoid function as an element (Step S703). The learning device 10 calculates the sum of all the calculated elements (Step S704), and divides the elements by the sum to calculate the probability of each class (Step S705).

### Effects in First Embodiment

In this embodiment, the calculation unit 121 calculates an output function whose variable is an output signal of an output layer in a neural network, the output function having a non-linear log likelihood function. The update unit 122 updates parameters of the neural network based on the output signal such that the log likelihood function of the output function is optimized.

In this manner, the learning device 10 in this embodiment performs learning using a function created without adding any parameter as an output function on the basis of softmax. The output function has a non-linear log likelihood function, and hence the expression ability of output is not limited by the dimension of input. Thus, according to this embodiment, deep learning with improved expression ability can be efficiently performed.

The calculation unit 121 calculates an output function obtained by replacing an exponential function included in softmax with the product of the exponential function and a predetermined function having no parameter, the output function having non-linear log likelihood function. For example, the calculation unit 121 can calculate an output function obtained by replacing an exponential function included in softmax with any one of the product of the exponential function and a sigmoid function, a sigmoid function, and softplus. The log of each of the functions after the replacement is non-linear.

[System Configuration, Etc.]

The components in the illustrated devices are functionally conceptual, and are not necessarily required to be physically configured as illustrated. In other words, a specific mode for dispersion and integration of the devices is not limited to the illustrated one, and all or part of the devices can be functionally or physically dispersed or integrated in any unit depending on various kinds of loads, usage conditions, and any other parameter. In addition, all or any part of the processing functions executed by the devices may be implemented by a CPU and programs analyzed and executed by the CPU, or implemented by hardware by wired logic.

Among the pieces of processing described in this embodiment, all or part of the processing that is described as being automatically executed can also be manually executed, or all or part of the processing that is described as being manually executed can also be automatically executed by a known method. In addition, the processing procedure, the control procedures, the specific names, and the information including various kinds of data and parameters described herein and illustrated in the accompanying drawings can be freely changed unless otherwise specified.

[Program]

In one embodiment, the learning device 10 can be implemented by installing a learning program for executing the above-mentioned learning processing onto a desired computer as package software or online software. For example, by causing an information processing device to execute the above-mentioned learning program, the information processing device can function as the learning device 10. The information processing device as used herein includes a desktop or notebook personal computer. In addition, the category of the information processing device includes mobile communication terminals such as a smartphone, a mobile phone, and a personal handyphone system (PHS) and slate terminals such as a personal digital assistant (PDA).

The learning device 10 can be implemented as a learning server device in which a terminal device used by a user is a client and service related to the above-mentioned learning processing is provided to the client. For example, the learning server device is implemented as a server device for providing learning service whose input is a parameter before update and whose output is a parameter after update. In this case, the learning server device may be implemented as a Web server, or may be implemented as a cloud for providing service related to the above-mentioned learning processing by outsourcing.

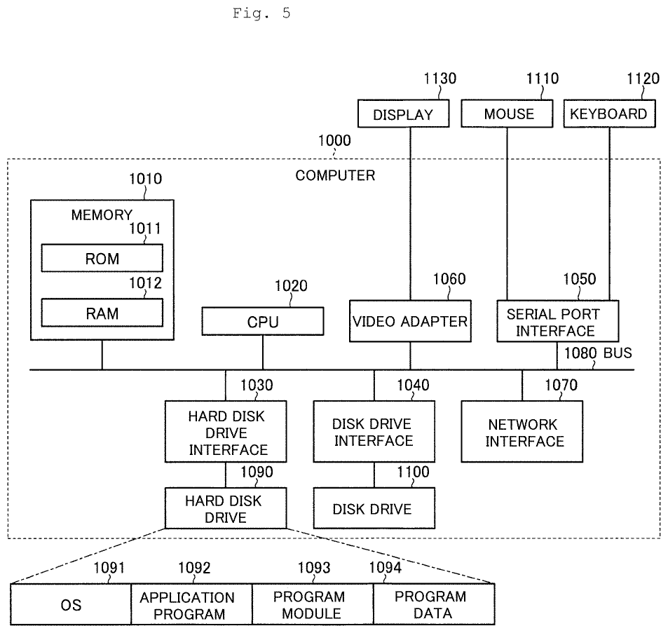

FIG. 5 is a diagram illustrating an example of a computer for executing a learning program. For example, a computer 1000 includes a memory 1010 and a CPU 1020. The computer 1000 includes a hard disk drive interface 1030, a disk drive interface 1040, a serial port interface 1050, a video adapter 1060, and a network interface 1070. The units are connected by a bus 1080.

The memory 1010 includes a read only memory (ROM) 1011 and a RAM 1012. For example, the ROM 1011 stores therein a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted to the disk drive 1100. For example, the serial port interface 1050 is connected to a mouse 1110 and a keyboard 1120. For example, the video adapter 1060 is connected to a display 1130.

For example, the hard disk drive 1090 stores therein an OS 1091, an application program 1092, a program module 1093, and program data 1094. In other words, programs for defining processing in the learning device 10 are implemented as the program module 1093 in which computer-executable codes are written. For example, the program module 1093 is stored in the hard disk drive 1090. For example, the program module 1093 for executing the same processing as the functional configurations in the learning device 10 is stored in the hard disk drive 1090. The hard disk drive 1090 may be substituted by an SSD.

Setting data used for the processing in the above-mentioned embodiment is stored in, for example, the memory 1010 or the hard disk drive 1090 as the program data 1094. The CPU 1020 reads the program module 1093 and the program data 1094 stored in the memory 1010 and the hard disk drive 1090 onto the RAM 1012 as needed, and executes the processing in the above-mentioned embodiment.

The program module 1093 and the program data 1094 are not necessarily required to be stored in the hard disk drive 1090, and, for example, may be stored in a removable storage medium and read by the CPU 1020 through the disk drive 1100. Alternatively, the program module 1093 and the program data 1094 may be stored in another computer connected through a network (such as a local area network (LAN) and a wide area network (WAN)). The program module 1093 and the program data 1094 may be read from another computer by the CPU 1020 through the network interface 1070.

### REFERENCE SIGNS LIST

10 Learning device
11 Storage unit
12 Control unit
121 Calculation unit
122 Update unit

1. A learning device, comprising:
a processor configured to perform calculating an output function whose variable is an output signal of an output layer in a neural network, the output function having a non-linear log likelihood function; and an update unit for updating a parameter of the neural network on the basis of the output signal such that the log likelihood function of the output function is optimized.

2. The learning device according to claim 1, wherein the calculating calculates an output function obtained by replacing an exponential function included in softmax with a product of the exponential function and a predetermined function having no parameter.

3. The learning device according to claim 1, wherein the calculating calculates an output function obtained by replacing an exponential function included in softmax with any one of a product of the exponential function and a sigmoid function, a sigmoid function, and softplus.

4. A learning method to be executed by a computer, comprising:
a calculation step for calculating an output function whose variable is an output signal of an output layer in a neural network, the output function having a non-linear log likelihood function; and an update step for updating a parameter of the neural network on the basis of the output signal such that the log likelihood function of the output function is optimized.

5. A non-transitory computer readable medium including a learning program for causing a computer to function as the learning device according to claim 1.
